(19) United States
(12) Patent Application Publication
(10) Pub. No.: US 2012/0120483 A1
(43) Pub. Date: May 17, 2012

(54) LASER SYSTEM FOR PROCESSING MATERIALS WITH MEANS FOR FOCUSSING AND ANTICIPATING SAID FOCUSSING OF THE LASER BEAM; METHOD OF OBTAINING A LASER BEAM AT THE EXIT OF AN OPTICAL FIBRE WITH PREDETERMINED VARIANCE

(76) Inventors: Marco Tagliaferri, Taino (Varese) (IT); Fabio Cannone, Milano (IT)

(21) Appl. No.: 13/386,171

(22) PCT Filed: Jul. 21, 2009
(86) PCT No.: PCT/IT09/00322

§ 371 Date: Jan. 20, 2012

(51) Int. Cl. G02B 6/32; G02B 13/14; G02B 27/10

(52) U.S. Cl. 359/356; 359/642; 359/618

(57) ABSTRACT

A laser system for processing thin film composite materials, such as solar cells and in general materials produced by depositing various layers of dielectric, semiconductor and conductor substances on rigid or flexible substrates of glass and/or polymers, comprising a laser generator (10) producing a laser beam; means (11, 12, 15) for transferring said laser beam into an optical fibre (14); and a focuser (17) applied to the end of said optical fibre (14) to supply said laser beam to said materials, wherein said transfer means (11, 12, 15) comprise a lens for focusing said laser beam and, coupled to said focusing lens, means for anticipating the focusing of said laser beam relative to the surface of said fibre (14) by a predetermined value.

The present invention relates to a laser system for processing materials, in particular for thin film layers, for example for solar cells. The traditional laser system for processing thin film layers comprises a laser source and a complex system of lenses required to divide the laser beam, homogenize it and transport it onto several processing lines. This is normally achieved in air. The complexity, the need for constant maintenance and the high cost of the optical system which divides the beam along several lines, result in high cost and poor flexibility in any necessary spatial repositioning of the lines (in the case of new processings), with considerable impact on the efficiency of the production process. Moreover, the homogenization optics may be a series of microlenses or a slit of suitable dimensions. Microlenses are extremely costly, whereas a slit results in a high power loss.

The main characteristics required in laser processing of thin film components are quality, productivity and flexibility.

The quality of the processing process depends on the laser beam quality, i.e. the ability to selectively and uniformly remove material without producing side effects.

Selective removal involves a clear identification of the fluence thresholds in the damage and absorption of the different materials and hence control of the fluence gap existing therebetween, hence ensuring that the process proceeds with quality. It is fundamentally important that in processing a layer of the thin film material, the adjacent layer through which the beam transits is not energetically notched.

The process quality depends on the uniformity and repeatability of the tracts.

The process repeatability is strictly related to the fact of producing lines which are all mutually equal. This is highly dependent on the homogeneity of the processing conditions resulting from the constancy of the characteristics of the laser pulses and the stability of the system for handling the material to be processed. In addition, to ensure sufficient processing reproducibility, the system for focusing the beam onto the sample must ensure adequate field depth, such as to absorb not only the positioning tolerance along the focal axis of the handling system but also the variation in the thickness of the substrate on which the layers are deposited.

The productivity of the processing system for composite thin film materials depends directly on the number of lines produced in a unit of time, and hence is dependent on the product of the scribing speed of an individual line multiplied by the number of lines used in parallel. Considering the fact that a speed increase beyond values of the order of 1.5-2 m/s is not economically advantageous, the useful productivity for a scribing system for thin film panels must be obtained by using a number of processing lines operating in parallel sufficient to obtain the desired productivity.

Process flexibility is determined by the requirement to be able to remotize the beam with extreme ease.

This does not mean only removing the laser source from the working surface, but also having the ability to easily and quickly vary the distance between the processing lines operating in parallel.

The use of multiple laser processing lines can be achieved in two ways: either each laser line has a corresponding laser of low power such as to enable processing; or each laser line originates from the division of a laser beam produced by a source of power such as to enable simultaneous processing of several lines.

The main reason for using a single power laser source divided into several processing lines is that it has the advantage of having to control only one laser unit, in terms of laser parameters (power, beam quality, electronics, software).

The method used to obtain several laser lines from a single source is that of optical division in air. It is noted that a laser beam can be divided by lenses by controlling the reflected and transmitted light components.

Moreover the importance of said critical points varies depending on whether the laser beam is a single mode beam or a multimode beam. An object of the present invention is to provide a laser system for processing materials which is able to obviate the drawbacks of the known art.

Another object of the present invention is to provide a laser system for processing materials which is of simple construction while at the same time being efficient.

According to the present invention, these and further objects are attained by a laser system for processing materials, comprising a laser generator producing a laser beam; means for transferring said laser beam into an optical fibre; and a focuser applied to the end of said optical fibre to supply said laser beam to said materials; characterised in that said transfer means comprise a lens for focusing said laser beam and, coupled to said focusing lens, means for anticipating the focusing of said laser beam relative to the surface of said fibre by a predetermined value.

These objects are also attained by a method for obtaining a laser beam at the exit of an optical fibre such that it has a predetermined mean power and a predetermined standard deviation, characterised by comprising the step of using a monomode laser generator which supplies a laser beam to a multimode optical fibre via a focusing lens; and by anticipating the focusing of said laser beam relative to the surface of said fibre by a predetermined value.

Further characteristics of the invention are described in the dependent claims.

This laser system is characterised by a multimode optical fibre which simultaneously performs the operation of transporting the laser beam to its processing point and of adapting the laser beam to the optimal intensity distribution for processing.

The typical critical points in a process for processing composite thin film materials with a multiplicity of optical fibre lines, which are overcome by the described laser system, are:

a—risk of damaging the fibres;

b—insufficient uniformity of the produced beam;

c—diversity of the processing performed by the different lines.

All these critical points have been confronted and overcome in developing this system.

In detail:

a—damage to the optical fibres. The fluences used for processing certain materials used in making thin film composites can reach values of the order of some tens of J/cm². In some cases these fluences are close to the fluences which damage the surfaces of silicon optical fibres, even if antireflective dielectric layers are absent. In particular, if the surface damaging fluence range for infrared radiation does not give particular preoccupation (200-500 J/cm²), the criticality arises in the case of visible radiation (60-175 J/cm²) (see G. Mann, J. Vogel et al. “laser-induced surface damage of optical multimode fibers and their preforms” Appl. Phys A (2008) Vol. 92 853-857). To resolve this first criticality, it is proposed to suitably vary the focusing position of the fibre launching system from its surface, to ensure long-lasting integrity of the fibre while maintaining the fluence value at the interface sufficiently far from the known damage limit. Considering the fact that the onset of damage is a statistical event, we consider that a safety margin which minimizes this risk, in the specific case of applications dedicated to industrial production, is a limiting value not exceeding 20% of the threshold damage fluence (i.e. damage threshold 60 J/cm²; maximum applied fluence<12 J/cm²).

b—the laser beam emerging from an optical fibre is represented by the intensity distribution, which is measured by a laser beam analyzer and statistically analyzed in terms of mean intensity <I> and variance ∂I. The intensity uniformity of this spot is defined as the ratio between these two quantities (see equation 1).

Employing the proposed formalization, it can be seen to be possible to select the parameters for launching the laser beam into the fibre and the fibre length such as to ensure sufficient uniformity to achieve processing quality, i.e. such that the fibre produces a beam which is not of flat top type but has an intensity distribution of suitable shape, the variance of which is less than the fluence range existing between the required fluence value for completely removing a layer of a material and the fluence which would damage the constituent material of the adjacent layer.

c—the equality of the processing produced by different lines is ensured by the invariance of shape, of mean value and the variance of the intensity distribution of the beams produced by the different lines.

The beam shape is defined by the shape of the cross-section of the fibre core of which the optical focusing system produces a suitably magnified image on the working surface.

It has been verified that this condition is satisfied for each processing line using a polarized laser beam achieving stationary splitting conditions.

We have also verified that the beam shape, the mean value and the intensity distribution variance remain unvaried with respect to the movement of the optical fibre required by the processing system, hence the processing quality produced by each line is unvaried with respect to the fibre movement.

According to the present invention, beam homogenization and remotization is achieved by a single element, the optical fibre, which replaces the complex transport and homogenization of the air beam composed of lenses, mirrors, slits (introducible to give the preferably square shape to the beam) and microlenses (to produce beam homogenization).

Introduction of the fibre is advantageous in providing various advantages.

It enables air transport and homogenization lenses to be eliminated. This hence reduces the criticalities in lens control and the costs, to attain a high system simplification. Hence a single object, namely the optical fibre, replaces two systems (the homogenization and remotization system) which are complex and costly.

It enables efficiency to be increased in terms of power. The introduction of an optical system for beam homogenization and shape selection (circular or square) introduces a considerable power loss generally not less than 30%. In the proposed system the power loss is reduced to values not exceeding 15%. This percentage includes losses due to transport, beam homogenization and the determination of the beam shape imposed by the fibre selection.

It ensures greater flexibility.

The square cross-section fibre enables qualitatively better processings to be achieved by reducing overlap, for example compared to fibres of circular cross-section in the case of linear tracks, and by increasing the processing speed, hence ensuring an increase in productivity (more rapid) and quality (lines all equal).

It represents an innovation in the value chain. In the traditional system the persons professionally involved are: the laser source supplier, the system supplier, the optical integrator and the thin film panel producer. The system here proposed eliminates the optical integrator. A professional person occupied with the maintenance and control of the complex system of lenses responsible for homogenization and remotization is no longer required. In this system these actions are carried out by the optical fibre, which is requires no maintenance and control.

The characteristics and advantages of the present invention will be apparent from the ensuing detailed description of one embodiment thereof, illustrated by way of non-limiting example in the accompanying drawings, in which:

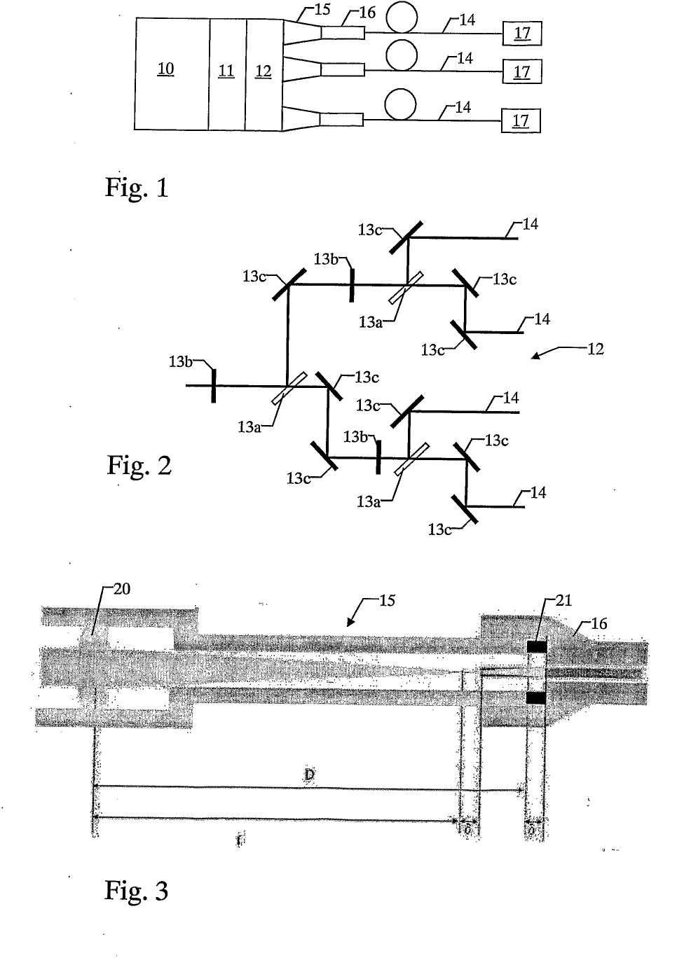

FIG. 1 shows schematically a laser system for processing materials, in accordance with the present invention;

FIG. 2 shows schematically a system for separating the optical beams of the laser system for processing materials, in accordance with the present invention;

FIG. 3 shows schematically a first embodiment of a focuser for the optical beams of the laser system for processing materials, in accordance with the present invention;

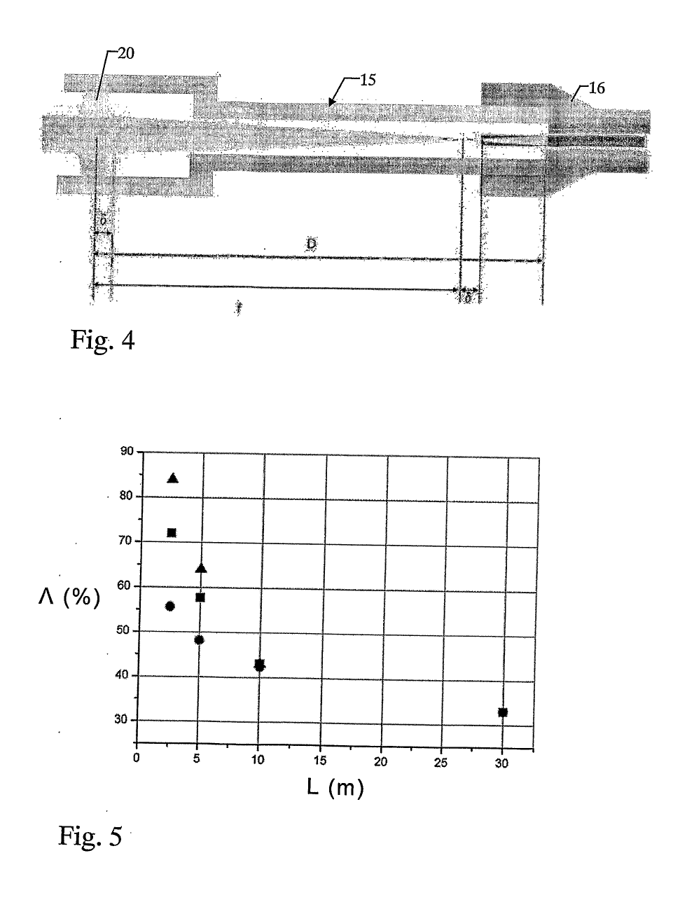

FIG. 4 shows schematically a second embodiment of a focuser for the optical beams of the laser system for processing materials, in accordance with the present invention;

FIG. 5 shows graph representing the variation in the uniformity Λ of the laser beam intensity as a function of the fibre length the launching conditions, in accordance with the present invention.

With reference to the accompanying figures, a laser system for processing materials, in accordance with the present invention, comprises a single mode laser 10, preferably linearly polarized and stationary, generating a power of about 10 W in Q-switching regime pulsed at 10 ns with emission at 532 nm. The laser 10 is interfaced with an optical magnification system 11 which simultaneously enables beam collimation and dimensioning of the laser beam wₗₐₛₑᵣ. The magnification system 11 is connected preferably to a separation system 12 which enables the laser beam to be separated into a certain number of indistinguishable lines. This system 12 is composed of a series of polarizing beam dividers 13a angled at 45° which, by means of a series of half wave strips 13b (utilizing the fact that the laser beam is polarized), achieves suitable balancing between all the lines. The dielectric mirrors 13C of high reflectivity for the wavelength, and angled at 45°, are used to ensure equality of the paths of the various lines.

The intensity losses due to these lenses are negligible. Each line is connected to an optical fibre 14 via an alignment and focusing system 15 known as a fibre port. The alignment and focusing system 15 is a mechanical interface housing the focusing lens 20, the focal length of which is selected on the basis of the level of uniformity to be obtained (see next paragraph). It enables alignment between the fibre inlet and laser beam. Optimization of the alignment is fundamentally important for optimizing the coupling effectiveness of the beam within the fibre core. Finally, the alignment and focusing system 15 is screwed onto the thread enabling the fibre 14 to be connected to the connector 16. Typically this system should be aligned such as to focus the laser beam onto the fibre inlet. Considering those energy fluencies, energy being defined as the energy on the surface, which are typical of scribing processes on thin film, there is a high probability of damaging the fibre surface. For this reason, in this system the distance D is varied by a submillimetric spacer 21 of length δ. The parameter D is defined as the distance between the plane of the lens 20 and the mechanical abutment between the alignment and focusing system 15 and the connector 16. In this manner the beam is focused at a distance δ from the fibre inlet surface such that the fluence at the air-fibre interface is reduced on the basis of δ. Mechanically the tube of the alignment and focusing system 15 is lengthened by a quantity δ. As an alternative to the spacer 21 the same result can be obtained by housing the lens 20 on a disc with screws and a spring which enable it to translate along the optical axis by a quantity δ. The disc is moved by three screws and held in position by three springs. The laser beam is launched into the fibre 14 by the alignment and focusing system 15. The fibre 14 is a multimode fibre preferably of square cross-section. Fibres with other core cross-sections, for example rectangular, circular, triangular, hexagonal or generally any shape able to produce area or line texturing can be used. At its other end the fibre is connected to a focuser 17 which enables the dimension of the laser beam on the thin film to be modulated. The focuser 17 consists of two lenses. The first is a collimating lens of focal length fc. The second is a lens which focuses the beam onto the sample being processed at a focal length ff. The dimension of the beam (radius) on the material is wₛₚₒₜ=ff/fc*w_{fibre}, where w_{fibre} is the radius or half side of the fibre cross-section. The number of lines, i.e. the number of fibres which can be interfaced with the laser source depends on the maximum energy produced by the laser and hence on the material processing threshold.

Although the advantages of using a multimode laser source are generally known, the choice of a single mode laser source is dictated by:

a) stationariness of the dimension and distribution of intensity of the laser spot as the laser power varies;

b) high efficiency of the frequency conversion process (second harmonic generation);

c) pulse energy stability;

d) polarized laser beam;

e) propagation invariance relative to optical path length.

This laser beam produces identical processing lines, ensuring high material processing repeatability.

In the light of this it becomes advisable to choose a single mode beam. In contrast, the intensity distribution of a multimode beam is more uniform than that of a single mode beam, which by definition has a Gaussian form.

The fact remains that if a multimode laser source were available having all the aforesaid characteristics, i.e. stationariness of the produced pulses, pulse energy stability, high conversion efficiency and defined and stationary polarization state, its use would be effective in obtaining the required specifications with suitable modifications which take into consideration the specific value of the source quality factor M².

The term “single mode laser source” means a source in which 1.05≦M²≦2.

Moreover the source can have wavelengths both in the visible and in the infrared with wavelengths between 0.3 and 1.09 μm.

In this section we shall illustrate two functional relationships which demonstrate how the choice of suitable parameters for the optical fibre, preserved by virtue of that illustrated in the preceding point, enable multi-layer composite materials to be processed with quality and repeatability.

The functional relationships relate to:

a) process depth

b) beam intensity distribution uniformity.

Let 2wₛₚₒₜ be the dimension of the processing tract.

This is related to the process field depth by equation (1) and must take into consideration:
material thickness (in the case of film of a few μm or sub-μm thickness, the relationship is always verified for radiation in the visible and near IR)
mechanical tolerance of the processing system (typically≅100 μm)
thickness tolerance of the substrate on which the layers are deposited (typically<100 μm)

The optical field depth, also known as the Rayleigh Range, is generally defined as:

$$Δ z = \pm \frac{π {w}_{spot}^{2}}{λ} \cdot \frac{1}{{M}_{out}^{2}} \qquad ( 1 )$$

and represents the distance at which the dimension of the laser spot, which operates on the material, varies by a factor \sqrt{2}, where M²ₒᵤₜ represents the beam quality parameter of the laser beam emerging from the fibre. In order to define a practical quality criterion for the process, it is fundamentally important to relate this optical parameter to a process parameter.

In a process for processing thin film layers the efficiency of this precessing is reached by ensuring spot uniformity within a certain range of the optical axis (±Δz*) which has as its mean point the focal processing plane (z_{focus}). Practically, Δz* must take account of the mechanical tolerances of the system for moving material in the focal axis direction, the thickness of the material layer to be removed, and the tolerance of this thickness. We shall define (z_{focus}±Δz*) as the optical axis range within which the dimension of the processing tract varies by 10%.

If w_{fibre} is the dimension of the half side or radius of the fibre core and NAₒᵤₜ the numerical aperture of the beam emerging from the fibre, then M²ₒᵤₜ is related to the “beam parameter product” BPPₒᵤₜ by:

BPPₒᵤₜ=w_{fibra}·NAₒᵤₜ (2)

by means of (3):

$${M}_{out}^{2} = \frac{{BPP}_{out}}{Limite di Diffrazione} = \frac{{w}_{fibra} \cdot {NA}_{out}}{Limite di Diffrazione} \qquad ( 3 )$$

where the diffraction limit is 0.34 mm mrad for infrared radiation (1064 nm) and 0.17 mm mrad for green radiation (532 nm).

We have verified that NAₒᵤₜ=NA_{fibre} if NA_{fibre}=NAᵢₙ (4), or NAₒᵤₜ=NA_{fibre} if NA_{fibre}≧NAᵢₙ (4) if using a sufficiently long fibre (see numerical example), where NAᵢₙ is the numerical aperture at the fibre entry.

Hence equation (4) is rewritten:

$${M}_{out}^{2} = \frac{{w}_{fibra} \cdot {NA}_{in}}{Limite di Diffrazione} \qquad ( 5 )$$

The value of NAᵢₙ is established starting from the dimension of the spot emerging from the laser (wₗₐₛₑᵣ) and from the lens focal length f. In this respect, considering a laser beam of radius wₗₐₛₑᵣ focused into a fibre of numerical aperture NA_{fibre} by a lens of focal length f, the entry angle imposed by the lens is well approximated by:

$${NA}_{in} = \frac{{w}_{laser}}{f} \qquad ( 6 )$$

It is noted that the lens of focal length f produces a beam having in the focal plane a radius wᵢₙ:

$${w}_{in} = \frac{λ f}{π {w}_{laser}} \cdot \frac{1}{{M}^{2}} . \qquad ( 7 )$$

However, not all wᵢₙ values are allowed. Only those values are possible for which the laser energy fluence is less than the fibre damage fluence in accordance with the introduction of a certain spacer δ (see numerical example).

The system of equations (1)→(7), which can be summarized into the functional relationship

Δz*=Δz*(w_{fibre}, NA_{fibre}, f) (8)

enables those optical fibre parameters and fibre launching conditions to be chosen which produce a process depth such as to ensure quality and productivity of the system presented herein.

Beam uniformity means uniformity of laser beam intensity distribution.

We shall define “uniformity of laser beam intensity distribution” as the ratio between mean intensity <I> and standard deviation ∂I calculated on a matrix which represents the intensity distribution of the beam leaving the fibre:

$$Λ = \frac{\partial I}{〈 I 〉} \qquad ( 9 )$$

The more uniform a beam, the smaller is the value of [symbol] . In contrast, large [symbol] values indicate large disuniformity.

Let us consider a composite material consisting of two thin film layers of different materials, known as (a) and (b). Material (b) must be processed without damaging material (a), whether material (b) is removed by transiting the beam through the layer of material (a) or not. Let Fₐ and F_{b} be the damage fluence thresholds of materials (a) and (b) respectively, i.e. the fluence values required to produce adequate removal of the layer of material (b) and the fluence value such as to produce significant damage of material (a), considering “adequate” and “significant” as being relative to the effectiveness that these processings achieve in obtaining correct operation of the device formed by said composite material. ΔF=Fₐ−F_{b}, for a determined wavelength. For the processing to be of quality and repeatability, a beam must be used with an intensity distribution which satisfies the condition ∂I<ΔF (10).

FIG. 5 shows the variation in beam uniformity Λ as the following vary:

a) Fibre length (L);

b) Numerical aperture of the optical fibre used (NA_{fibre});

c) Numerical aperture of launching (NAᵢₙ);

With ▪ the fibre parameters are NA_{fibre}=0.16, w_{fibre}=50 μm, NAᵢₙ=0.07; with the fibre parameters are NA_{fibre}=0.16, w_{fibre}=50 μm, NAᵢₙ=0.14; with ▴ the fibre parameters are NA_{fibre}=0.20, w_{fibre}=50 μm, NAᵢₙ=0.07.

It should be noted that the uniformity value obtained with the aforesaid optical fibres attains the value of 30%. It is reasonable to expect that this value can be considerably reduced by using optical fibres with different parameters.

Hence the focal length of the lens is not chosen arbitrarily, but is such as to ensure the functional relationship (4).

The system of equations (1)→(9), which can be summarized into the functional relationship

[symbol]

= [symbol] (L,f) (11)

enables those optical fibre parameters and fibre launching conditions to be selected which produce a beam uniformity such as to ensure quality and productivity for the system presented herein.

In conclusion, knowing the parameters required for the processing, namely:

a) the dimension of the processing spot, i.e. wₛₚₒₜ,

b) the required process depth, i.e. z*,

then the following fibre parameters can be chosen by means of the functional relationship (8): core dimension (w_{fibre}) and fibre numerical aperture (NA_{fibre}),

c) knowing the existing fluence gap, ΔF, the functional relationships (11) can be used to suitably select the fibre length L, and the conditions for launching the laser beam into the fibre, i.e. the focal length of the launching lens, f, all without damaging those materials not concerned in the processing and while preserving the optical fibre integrity.

The duplicity of relationship (4) is justified considering the practical limitations imposed by the angular tolerances inherent in processing the fibre surfaces, their connectors, and the mechanics of launching into the fibre, as indicated in the following numerical example.

In the subsequent numerical examples, we shall demonstrate that by considering the described modelization we obtain a range of parametric values which result in quality processing of thin wafers without fibre damage.

The value of δ is determined on the basis of the fibre damage threshold.

In processing silicon we can consider mean process fluencies of 0.75 J/cm². We shall consider a single mode green laser beam (0.532 μm) having a spot of 1.6 mm diameter, which is focused by a lens of focal length f=11 mm on a fibre having a square core of 100 μm side. The spot focused by the lens is 2.1 μm, hence the fluence on the optical fibre is 532 J/cm², i.e. nearly 10 times greater than the lower limit of the fibre damage threshold for visible radiation (60-175 J/cm²).

A 260 μm spacer 21 is introduced. Hence the focus produced by this lens will no longer be on the fibre face but retracted by a quantity δ=260 μm with the result that a beam of radius w₁=20.5 μm forms on this interface. Consequently the fluence is about 90 times less than that obtained without this spacer, i.e. about 5.6 J/cm².

A similar result is obtained by positioning the lens (20) on the disc with three screws of 80 tpi and turning the screws through one complete revolution. In this condition the lens retracts by δ=275 μm and the beam on the fibre face has a radius of wᵢₙ=22.5 μm with a consequent fluence reduction to 4.7 J/cm², a value reduced by one order of magnitude compared with the fibre damage threshold fluence.

Generally a range of δ values can be introduced having a lower end, δ_{inf}≅75 μm, which is dictated by the minimum radius obtained to induce a fluence close to damaging, 60 J/cm², and an upper end, δmax 600 μm, which is dictated by a spot radius close to the fibre dimension (50 μm).

We shall now give a numerical example of our formalization considering the processing of a wafer composed of silicon and TCO (transparent conductive oxide). The silicon is to be processed without damage to the TCO, i.e. ∂I<<ΔF, obviously without damaging the fibre which has a damage threshold of 60 J/cm². The m required field depth is ±300 μm and the tract dimension is 100 μm. The required process depth advises the use of a multimode fibre of NA_{fibre}=0.16 and a half side length W_{fibre}=50, having a square cross-section. The laser used is linearly polarized stationary, with a spot dimension wₗₐₛₑᵣ=800 μm, and emission wavelength 532 nm. The fluence threshold for completely removing the silicon layer, known as the silicon damage fluence threshold, is 0.5 J/cm², whereas for TCO it is 1.3 J/cm². As ΔF=0.8 J/cm² and the degree of uniformity for optimal beam distribution intensity is that for which δI<ΔF=0.8 J/cm², a fibre length L=5 m is required.

Using a lens of focal length f=11 mm we obtain NAᵢₙ=0.07, i.e. NA_{fibre}=2.3 NAᵢₙ. By varying the focal length f, the value of NAᵢₙ would decrease to hence satisfy condition (4) NA_{fibre}=NAᵢₙ, which ensures best uniformity. This condition might not be attainable because of an intrinsic angular tolerance to the system. This tolerance derives from the degree of processing precision of the optical fibres. The presence of a surface cutting angle θ to the optical axis gives rise to a system tolerance of ±δθ. The choice of NAᵢₙ=0.07 although not fully satisfying condition (4) enables the angular tolerance to be absorbed even for large cutting angles (θ≅5°).

The results obtained in this manner are:

a) Λ=57% is such that ∂I=0.4 J/cm²<ΔF=0.8 J/cm² so as not to damage the TCO layer being processed.

b) The optical field depth is ≅±300 μm. We verify that in ±300 μm the spot dimension varies by 10%. We obtain z_{focus}=5.45 mm, at this optical axis value the spot having a 106 μm side. We see that the spot dimension varies by 10% (106 μm-116 μm) within the range 5.2 mm-5.7 mm, i.e. 5.45±0.3 mm. In conclusion using the considerations made in the modelization, by suitably choosing the inlet parameters we are able to satisfy the required conditions.

We also evaluate the uniformity ( [symbol] ′) of the processing spot within the range 5.45±0.25 mm, it being seen that this also varies by about 10%. We have been able to reduce the increase in the fibre length without varying the other conditions. We consider this action unnecessary because the processing results do not improve, as the condition ∂I<ΔF is already satisfied. The cost of the fibre increases and intensity attenuation phenomena can be verified.

We would evidently have been able to reduce the value of [symbol] (FIG. 5) by increasing the fibre length without varying the other considerations. We consider this action unnecessary because:

a) the processing results do not improve, as the condition ∂I<ΔF is already satisfied,

b) the fibre cost increases,

c) intensity attenuation phenomena can be verified.

The square beam is not an ideal flat top beam but produces a beam with variance of ∂I=0.4 J/cm².

The use of a square spot is also advantageous in terms of effective laser energy used in the processing step. In this respect, all the energy contained in the beam which exceeds the threshold value is energy which is not successfully used in processing.

The fraction of a square spot fluence which effectively “works” in the process is 52% of the total. This percentage decreases to 33% for a Gaussian beam.

These comparisons are evidently made for equal fluencies.

The invariance of the spot dimension as pulse energy varies stresses the advantage of reducing the overlap of the processing spots to a minimum of 10-15%.

The main advantage is the ability to reduce overlap and hence increase the process speed for equal mean power used, ensuring scribing outlines with high quality, uniform straight edges.

The final advantage of the square beam compared with a Gaussian beam is highlighted by the non-variation in the spot dimension on varying the energy of the pulses produced by the laser source. Given the incremental nature of a Gaussian beam, it is evident that a pulse energy variation induces a variation of the gaussian function with a consequent variation in the dimension of the spot produced by the processing. The square form is not subject to this variation.

The introduction of the optical fibre into the system acts simultaneously as a beam homogenization element and as an element for transporting the beam onto the processing plane. This introduces into the thin material wafer processing system a considerable simplification, enabling the homogenization and transport optics to be eliminated, these being a source of complexity (alignment, cleaning) and cost (purchase and maintenance) (concept of system simplification).

The proposed optical/mechanical system which enables the focal position to be displaced relative to the fibre surface provides an extremely low cost solution which ensures that the optical fibre element is safeguarded.

Even though a square beam is not an ideal flat top beam, a wafer layer can still be processed with extreme efficiency without damaging the other, wafer materials, as the functional model always enables the system to be set such that ∂I<ΔF.

The functionalization and the proposed system enable solar cells to be processed with high efficiency and repeatability.

The use of a linearly polarized source enables a plurality of beams (splitting) to be produced ensuring production lines which are all equal to each other. In this manner a multiplicity of mutually identical production lines can be achieved (concept of plurality and homogeneity of all processings).

The proposed functional relationship is independent of the operating regime of the laser source and in particular of the time duration of the pulses produced. The relationship can be considered as directly applicable to pulses of duration different from that indicated in the examples.

1. A laser system for processing materials, comprising a laser generator producing a laser beam; means for transferring said laser beam into an optical fibre; and a focuser applied to the end of said optical fibre to supply said laser beam to said materials; characterised in that said transfer means comprise a lens for focusing said laser beam and, coupled to said focusing lens, means for anticipating the focusing of said laser beam relative to the surface of said fibre by a predetermined value.

2. A laser system as claimed in claim 1, characterised in that said laser generator produces said laser beam in single mode.

3. A laser system as claimed in claim 1, characterised in that said laser generator produces said laser beam as linearly polarized and stationary.

4. A laser system as claimed in claim 1, characterised by comprising a separator for separating said beam into a plurality of laser beams positioned downstream of said laser generator.

5. A laser system as claimed in claim 1, characterised in that said laser generator produces said laser beam with a wavelength between 0.300 and 1.090 μm.

6. A laser system as claimed in claim 1, characterised in that said laser generator operates in pulsed regime.

7. A laser system as claimed in claim 1, characterised in that said focusing lens is placed in a mechanical structure; said optical fibre comprising an inlet connector; said means for anticipating the focusing of said laser beam relative to the surface of said fibre by a predetermined value comprising a spacer positioned between said connector and said mechanical structure.

8. A laser system as claimed in claim 1, characterised in that said means for anticipating the focusing of said laser beam relative to the surface of said fibre by a predetermined value comprise means for moving said focusing lens.

9. A laser system as claimed in claim 1, characterised in that said predetermined value is determined such that the value of the fluence on the surface of said laser fibre is less than the value of the optical fibre damaging fluence.

10. A laser system as claimed in claim 1, characterised in that said multimode optical fibre simultaneously carries out the operation of transporting the laser beam to its processing point and of adapting the laser beam to the optimal intensity distribution for the processing.

11. A laser system as claimed in claim 1, characterised in that said optical fibre has a square cross-section.

12. A laser system as claimed in claim 1, characterised by comprising a magnifier for said laser beam, positioned downstream of said laser generator.

13. A method for obtaining a laser beam at the exit of an optical fibre, the intensity distribution of which has a predetermined variance, characterised by comprising the step of using a monomode laser generator which supplies a laser beam to a multimode optical fibre via a focusing lens; and by anticipating the focusing of said laser beam relative to the surface of said fibre by a predetermined value.

14. A method as claimed in claim 13, characterised by having a uniformity lower than 40%, by using an optical fibre with a core of dimensions 100 μm and numerical aperture 0.20.

15. A method as claimed in claim 13, characterised by using said multimode optical fibre of square cross-section.
